(19) United States
(12) Patent Application Publication
(10) Pub. No.: US 2013/0163246 A1
(43) Pub. Date: Jun. 27, 2013

(54) Light-Emitting Diode Lamp

(71) Applicant: Mikhail Juryevich Valyentsov, Moscow (RU)

(72) Inventor: Mikhail Juryevich Valyentsov, Moscow (RU)

(21) Appl. No.: 13/814,775

(22) PCT Filed: Dec. 7, 2010
(86) PCT No.: PCT/RU2010/000737

§ 371 Date: Feb. 7, 2013

(30) Foreign Application Priority Data
May 4, 2010 (RU) 2010117282

(51) Int. Cl. F21V 29/00

(52) U.S. Cl. CPC F21V 29/004
USPC 362/235; 362/249.02

(57) ABSTRACT

The technical result consists in a compact light emitter which does not produce a light loss and which illuminates at angles of 360×270×270 degrees, in which the radiator is designed so as to be capable of significantly increasing the area of the radiator without any growth in the dimensions of the lamp. The claimed technical result is achieved in that the light-emitting diode lamp, which comprises a bulb, a cap for insertion into a lampholder, light-emitting diodes which are coupled to the contacts of the cap via a microcircuit, and a radiator for transmitting heat from the light-emitting diodes, is characterized in that the light-emitting diodes are mounted on a heat pipe which is formed with a base and a hollow heat-transfer leg, and elements of the radiator which is connected to the base of the heat pipe are arranged around the bulb of the lamp and beneath this, wherein a heat-transfer medium which functions at the boiling phase is arranged inside the cavity of the heat pipe, and contacts of the electrical power supply to the light-emitting diodes are passed via conductor tracks or a wire running over the surface of the heat pipe.

### CROSS-REFERENCE TO RELATED APPLICATIONS

The present application claims priority to PCT App. No. PCT/RU2010/000737, filed Dec. 7, 2010, which claims priority to Russian Federation Pat. App. No. RU2010117282, filed May 4, 2010, both of which are incorporated by reference as if fully set forth herein.

### BACKGROUND

1. Field

The invention relates to a light-emitting diode lamp.

2. Description of the Problem and Related Art

Currently existing light emitting diodes LEDs lights, for example LED E27 series, have an unsightly appearance, are bulky, have low illuminating qualities (on average 300-500 lm) due to the fact that there is no way and nowhere to transfer the heat from the diodes.

Usually in the diode's light structures, the diodes are placed on a massive piece of metal, which accumulates heat by itself but dissipates heat to the outside area poorly. Consequently—all light structures of this kind have sectorial illumination because the base of the light is being taken by a massive metal radiator.

There is a technical solution disclosed in US2009046458, representing a traditional light, where the radiator slats are located outside of the illumination angles of the diodes. This construction does not allow enough heat withdrawal from the diodes, because the diode's illumination angle is 120 degrees, and eventually the diodes have to be placed far away from each other. Therefore, when the number of LEDs increases, the structure does not fit into a light, or it can fit when very weak diodes with about 200-300 lumens of light are being used.

Better solutions are found in US2009021944, CN101349411, where heat pipes are described in a quantity of 3 pcs, which extract heat from a metal hexagon on which circuit boards with diodes are placed. Therefore, the diode is not directly placed on the heat pipe. The light source is not a spot; a lot of light is lost (by reflecting form the protective bulb cover back to the hexagon). The structure is very bulky and heavy; there is a lot of metal inside the emitter, where it is unnecessary. The radiator in this structure is at the bottom of the light structure and implements the classic structure of light emitting diodes light.

### BRIEF DESCRIPTION OF THE DRAWINGS

The present invention is described with reference to the accompanying drawings.

FIG. 1 illustrates an exemplary embodiment of a light-emitting diode lamp as disclosed herein;

FIG. 2 illustrates a second exemplary embodiment of a light-emitting diode lamp; and

FIG. 3 illustrates a third exemplary embodiment of a light-emitting diode lamp.

### DETAILED DESCRIPTION

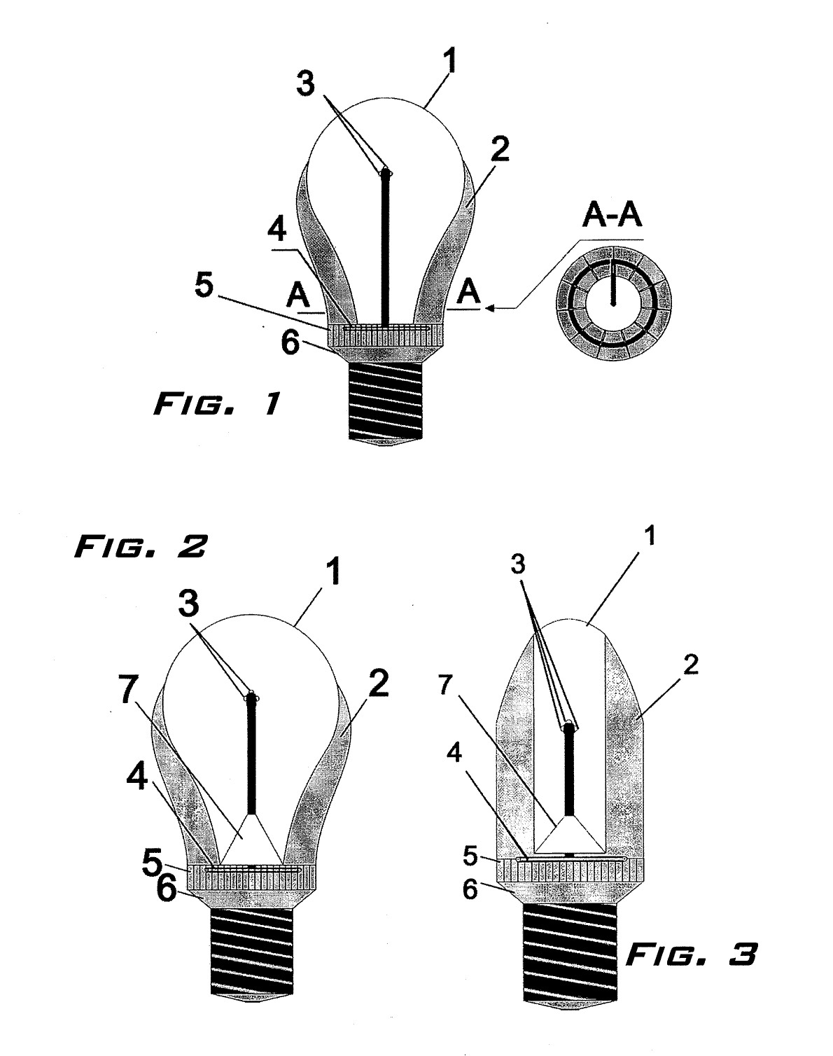

The various embodiments of the present invention and their advantages are best understood by referring to FIGS. 1 through 3 of the drawings. The elements of the drawings are not necessarily to scale, emphasis instead being placed upon clearly illustrating the principles of the invention.

This invention may be provided in other specific forms and embodiments without departing from the essential characteristics as described herein. The embodiments described are to be considered in all aspects as illustrative only and not restrictive in any manner. The appended claims rather than the following description indicate the scope of the invention.

The technical result of the claimed invention is a compact light emitter, which does not create light loss and emits light at angles 360×270×270 degrees, in which the cooling radiator is made with an ability of significantly increasing its surface area without a significant increase in the size of the light structure.

The declared technical result is achieved due to the fact that the method for manufacturing of LEDs light includes the usage of a bulb cover, base for insertion into the socket, light emitting diodes, electrically connected to the contacts on the base of the light, and is characterized by transferring heat from the light emitting diodes to the radiator; the difference is that the LEDs are being placed on the heat pipe, which consists of a base and a hollow heat transferring tube; the radiator parts connected to the base of the heat pipe, the heat pipe having a heat transfer agent within its chamber working at the changing phase, are being placed around the bulb and below the bulb; the power for the LEDs is being supplied via conductive paths or wires above the surface of the heat pipe.

Additionally the light emitting diodes light structure is equipped with a cone made of reflective material, placed at the base of the heat pipe to reflect the light rays falling to the upper part of the heat pipe base.

With reference now to the figures, the light structure is formed by surrounding a light dispersing matted bulb (1) (which may be made from plastic or glass) around a side with a secondary metal radiator (2), which can be made from light metal or metal alloys. The secondary radiator (2) is designed not to create shadows for the light thanks to its special structure with reflective surface, facing the inside of the light. Light emitting diodes (3) are placed in a sectorial way onto the heat pipe (4) to deliver the light distribution of 360 degrees (for example, 3 light emitting diodes with intervals of 120 degrees). The heat pipe (4) is made of complex shape with a base and a hollow stem filled with heat transferring agent; it can be made of nonferrous metal (e.g. aluminum or copper) or metal alloy, and it is to transfer heat from the light emitting diodes to the radiators.

The first way of transferring heat is from the heat pipe to the primary metal radiator (5), which is rigidly connected to the heat pipe (4) and to a secondary radiator (2) to achieve even heat distribution through both radiators. The second way of transferring heat is from the heat pipe to the secondary metal radiator (2). Standard light base with a plastic case driver (6) contains electronics to power and control the light emitting diodes, the power to which is being provided via wires or conductive paths on the surface of the heat pipe (4). In addition LEDs light can be equipped with a cone (7) having an apex oriented toward the LEDs (3) and made of specular material designed to reflect light rays radiating from the LED toward the top of the driver case.

The use of a heat pipe (4) to withdraw heat from LEDs (3) permits positioning the diodes in any convenient part of the light structure and thus obtain the desired illumination pattern from the light source (up to 360 degrees), and utilization of a radiator with a special structure, on one hand allows heat dissipation to the environment (air) more efficiently, on another hand excludes interference with luminous efficiency of the light and avoid shadows by the radiator.

The heat pipe (4) has a heat transfer agent inside working at a changing phase (e.g. distilled water under negative pressure). The effectiveness of heat recovery at a changing phase is much higher than during conventional heat recovery. When diodes are heated up to the point of phase transition, the water inside the pipe starts boiling bubble-free and condenses on the cooler end of the tube, where the condensation will effectively transfer heat to the radiators.

The inflow of liquid water back to the point of heating (where diodes are placed) is being implemented by the capillary structure of inner walls of the heat pipe. The pipe operates on a closed cycle, with a minimum temperature difference at the ends of the pipe.

Therefore the light structure is light, inexpensive to produce and extremely bright because all the extra heat is being transferred away from light emitting diodes by the heat pipe, allowing to power them with a higher electrical current, compared to when using a simple solid metal radiator.

The application of corresponding electrical circuits to power up diodes also allows for a light structure with adjustable brightness (dimmable), which is impossible in compact fluorescent lights.

As described above and shown in the associated drawings, the present disclosure is directed to an apparatus for a light-emitting diode lamp. While particular embodiments have been described, it will be understood, however, that invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A light-emitting diode lamp comprising:
a base,
a bulb cover attached to said base,
a thermally conductive radiator housed within said bulb cover and comprising a primary radiator mounted to said base and a heat pipe extending from said primary radiator;
one or more light-emitting diodes connected through an electrical circuit to contacts on said base and disposed on an end of said heat pipe distally from said base;
wherein said light emitting diodes; the radiator parts connected to the base of the heat pipe that has a heat transfer agent within its chamber working at the changing phase are being placed around the bulb and below the bulb;

2. The light emitting diodes lamp of claim 1 further comprising: a cone made of specular material, placed around the heat pipe to reflect the light rays radiating from said light-emitting diodes toward the base.
